(19) United States
(12) Patent Application Publication
(10) Pub. No.: US 2010/0270325 A1
(43) Pub. Date: Oct. 28, 2010

(54) DISPENSER WITH AFFIXING TAB

(76) Inventor: Brent R.G. FEARON, Cambridge (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/762,725

(22) Filed: Apr. 19, 2010

Related U.S. Application Data
(60) Provisional application No. 61/170,758, filed on Apr. 20, 2009.

(51) Int. Cl. B65D 83/08; B65D 83/00; F16B 47/00

(52) U.S. Cl. 221/45; 221/199; 248/205.3

(57) ABSTRACT

A dispenser includes a container having panels defining a cavity for holding a supply of a product. The panels include a top panel having an opening for dispensing the product and a side panel extending orthogonally to the top panel. The top panel is connected to the side panel along a top edge. The dispenser also includes an affixing tab extendable from the top panel along the top edge. The underside of the affixing tab is a mounting surface on which is an adhesive material. The affixing tab is moveable between a closed position and an open position. In the closed position, the affixing tab lies flat against the side panel. In the open position, the mounting surface is exposed and securable to a support surface using the adhesive such that the affixing tab and the adhesive are capable of securing the container to or suspending the container from a vertical or horizontal support surface.

### CROSS-REFERENCE TO RELATED APPLICATIONS

This application claims the benefit of U.S. Provisional Patent Application Ser. No. 61/170,758 filed on Apr. 20, 2009 by the present inventor, and entitled “DISPENSER BOX WITH AFFIXING TAB”, the entire contents of which are hereby incorporated by reference herein for all purposes.

### TECHNICAL FIELD

The invention relates to dispensers for products, and in particular, to dispensers for facial tissues.

### BACKGROUND

There exists a need for consumers to place a dispenser (such as a box of facial tissues) in areas where the dispenser, on its own, would not fit or stay. For example, consumers may need to have the dispenser attached to a horizontal, a vertical, a curved or angled surface, or even suspended over the side of a surface or suspended from underneath a surface above.

While there exist various dispensers having affixing devices, these prior art affixing devices have a number of drawbacks. Some of these devices, such as the flaps of the container shown in U.S. Pat. No. 2,096,107 (Haggerty), require screws or other fasteners. Other devices, such as the attachment means of the tissue dispenser shown in United States Patent Application Publication No. 2006/0096998A1 (Shabashkevich) are aesthetically unpleasing.

The cardboard dispensing box disclosed in U.S. Pat. No. 2,990,950 (Alexander) may be attached to a surface using adhesive on the foldable end panels, but the end panels have a number of limitations, and in particular, they do not appear to provide overly secure attachment to thin or rounded vertical surfaces.

Furthermore, none of the known prior art dispensers are capable, on their own, of being attached to a wide variety of different surfaces.

There is accordingly a need for an improved dispenser having an affixing device that has one or more advantages over the prior art affixing devices.

### SUMMARY

The subject dispenser comprises an affixing device in the form of an extendible affixing tab. On the underside of this tab is an adhesive strip that is used to affix the dispenser to a variety of surfaces. Because the adhesive strip is on a single tab that rotates up to 270 degrees from its closed position, the dispenser can be secured into a variety of positions (and to a variety of surfaces) far in excess of any single prior art within this genre. In addition to the dispenser with affixing tab being able to be attached to a horizontal or vertical surface, the strength of the affixing tab inherent in its design allows for the dispenser to also be hung or suspended from surfaces without creating excessive strain on the material or fabrication of the dispenser.

Incorporating the affixing tab into the design of the dispenser as described herein dramatically increases the functionality and practicality of the dispenser. As a result, the subject dispenser substantially increases the number of places where it may be used and, correspondingly, where the contents of the dispenser may then be accessed.

According to one aspect of the present invention there is a dispenser including a container having a plurality of panels defining a cavity for holding a supply of a product. The panels include a top panel having an opening for dispensing the product and a side panel extending orthogonally to the top panel. The top panel is connected to the side panel along a top edge. The dispenser also includes an affixing tab extendable from the top panel along the top edge. The affixing tab has a mounting surface with an adhesive thereon. The affixing tab is moveable between a closed position, in which the affixing tab lies flat against the side panel, and an open position, in which the mounting surface is exposed and securable to a support surface using the adhesive such that the affixing tab and the adhesive are capable of securing the container to the support surface.

The affixing tab and the top panel may be integrally joined together along the top edge.

Alternatively, the affixing tab may be a separate member affixed to the container. For example, the affixing tab may be a separate member affixed to the top panel of the container.

The affixing tab may be scored along the top edge so as to form a living hinge that pivotally couples the affixing tab to the container. Furthermore, the affixing tab may be pivoted from the closed position to the open position by pivoting the affixing tab by a pivot angle of up to about 270°. For example, pivoting the affixing tab from the closed position to the open position by a pivot angle of about 90° allows the container to be secured to and overhang from a top facing horizontal support surface. In another example, pivoting the affixing tab from the closed position to the open position by a pivot angle of between about 90° and about 180° allows the container to be secured to a vertical support surface. In yet another example, pivoting the affixing tab from the closed position to the open position by a pivot angle of between about 180° and about 270° allows the container to be secured to a bottom facing horizontal support surface.

The adhesive on the mounting surface of the affixing tab may be an adhesive strip.

The adhesive on the mounting surface of the affixing tab may be reusable such that the affixing tab can be releasably secured to the support surface. Furthermore, a portion of the adhesive on the mounting surface may releasably secure the affixing tab to the side panel when the affixing tab is in the closed position.

The container may be an elongate container having an elongate top panel with an elongate opening parallel to an elongate top edge, and the affixing tab may be an elongate affixing tab extendable from the top panel along the elongate top edge.

In other embodiments, the container may be an elongate container having an elongate top panel with an elongate opening orthogonal to a short top edge, and the affixing tab may be a narrow affixing tab extendable from the top panel along the short top edge.

The container may be a tissue box and the product may be a tissue. Accordingly, the cavity of the tissue box may be configured to hold a supply of tissues.

According to another aspect of the invention, there is a dispenser including a container having a plurality of panels defining a cavity for holding a supply of a product. The panels include a top panel having an opening for dispensing the product and a side panel extending orthogonally to the top panel. The dispenser also includes an affixing tab extendable from the top panel along a top edge of the top panel. The affixing tab has a mounting surface with an adhesive thereon. The affixing tab is moveable between a closed position, in which the affixing tab and the side panel are coplanar, and an open position, in which the mounting surface is exposed and securable to a surface using the adhesive such that the affixing tab and the adhesive are capable of securing the container to the surface.

The side panel may have a perforated border between the side panel and the affixing tab for defining and securing the affixing tab in the closed position. Separating the affixing tab and the side panel along the perforated border allows the affixing tab to move between the closed position and the open position.

The dispenser may also include a plastic liner attached to the inner surface of the container such that the plastic liner extends over a section of the side panel corresponding to the affixing tab.

The side panel may have at least one opening adjacent to the affixing tab for enabling a user to separate the affixing tab from the side panel along the perforated border.

The affixing tab may be scored along the top edge so as to form a living hinge that pivotally couples the affixing tab to the container.

Other aspects and features will become apparent, to those ordinarily skilled in the art, upon review of the following description of some exemplary embodiments.

### DRAWINGS

The drawings included herewith are for illustrating various examples of articles, methods, and apparatuses of the present specification and are not intended to limit the scope of what is taught in any way. In the drawings:

FIG. 1 is a perspective view of a dispenser including a container and an affixing tab made in accordance with an embodiment of the invention, in which the affixing tab is shown in the down/closed position;

FIG. 2 is a perspective end view of the dispenser of FIG. 1, in which the affixing tab is shown in the down/closed position;

FIG. 3 is a perspective side view of the dispenser of FIG. 1 with the affixing tab in the open/vertical position, showing an adhesive strip on the under-side (e.g. a mounting surface) of the affixing tab;

FIG. 4 is a cross-sectional view of the dispenser of FIG. 1, showing the affixing tab in the open/horizontal position and showing the affixing tab being manufactured as a congruent part or integral portion of the top panel of the container;

FIG. 5 is a perspective side view of the dispenser of FIG. 1, with the affixing tab in the open/horizontal position, demonstrating how the affixing tab can be used for hanging or suspending the container over the edge of a horizontal support surface;

FIG. 6 is a perspective side view of the dispenser of FIG. 1 with the affixing tab in the open/horizontal position, wherein the container is shown suspended over a rounded edge of a horizontal support surface;

FIG. 7 a close-up elevation view of the dispenser shown in FIG. 4;

FIG. 8 is a perspective view of the dispenser of FIG. 1 with the affixing tab in the open/vertical position, illustrating how the affixing tab is used to attach the container to a wall, a cabinet, or another vertical support surface;

FIG. 9 is a perspective view of the dispenser of FIG. 1 with the affixing tab in the open/intermediate position, illustrating how the affixing tab can be used to suspend the container from a vertical surface such that the container is at least partially recessed underneath and behind the vertical support surface;

FIG. 10 is a perspective view of the dispenser of FIG. 1 with the affixing tab in the open/intermediate position, illustrating how the affixing tab can be used to suspend the container from a bottom facing horizontal support surface;

FIG. 11 is a perspective view of the dispenser of FIG. 1 with the affixing tab in the open position, such that the container rests on top of a horizontal support surface on its side panel and the affixing tab is attached to the horizontal surface, with the contents of the container being extracted horizontally;

FIG. 12 is a plan view of the inner face of a one-piece blank or cut-out, from which the dispenser of FIG. 1 can be constructed;

FIG. 13 is a perspective view of a dispenser including a container and an affixing tab made in accordance with another embodiment of the invention, the container being taller and more slender than the container shown in FIG. 1;

FIG. 14 is a perspective view of a dispenser including a container and an affixing tab made in accordance with another embodiment of the invention, the container being shorter than the container shown in FIG. 1;

FIG. 15 is a perspective view of a dispenser including a container and an affixing tab made in accordance with another embodiment of the invention, wherein the affixing tab is a separate member attached to a top panel of the container; and

FIG. 16 is a perspective view of a dispenser including a container and an affixing tab made in accordance with another embodiment of the invention, wherein the affixing tab is defined by perforating and/or cutting the outline of the affixing tab into a side panel of the container.

### DETAILED DESCRIPTION

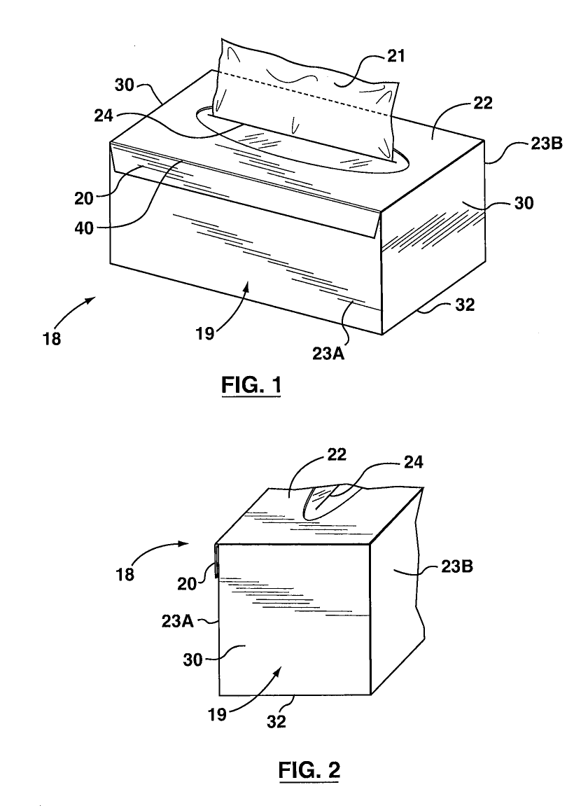

Referring to FIGS. 1-4, illustrated therein is a dispenser 18 made in accordance with an embodiment of the invention. The dispenser 18 includes a container 19 having a cavity for holding a product such as tissues 21 and a plurality of panels, which includes a top panel 22 (e.g. an upper horizontal panel), two side panels 23A and 23B, two end panels 30, and a bottom panel 32 (e.g. a lower horizontal panel). The top panel 22 has an opening 24 for dispensing the products (e.g. tissues 21) within the container 19.

The dispenser 18 also includes an affixing device in the form of a flap or an affixing tab 20 that is extendable from the top panel 22 along a top edge 40 of the top panel 22. For example, in the illustrated embodiment, the affixing tab 20 is integrally joined to the top panel 22 of the container 18 along the top edge 40.

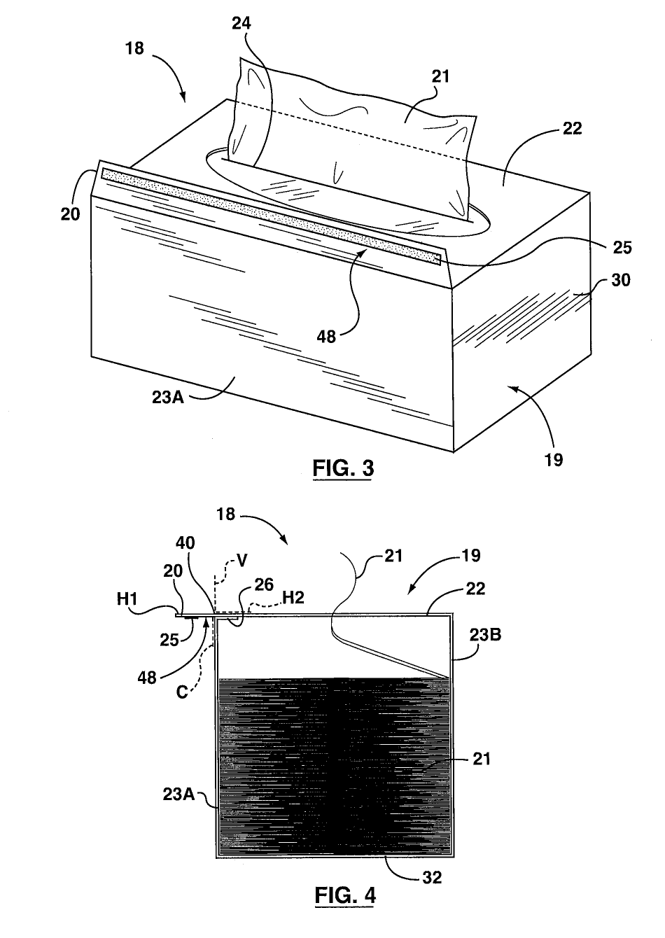

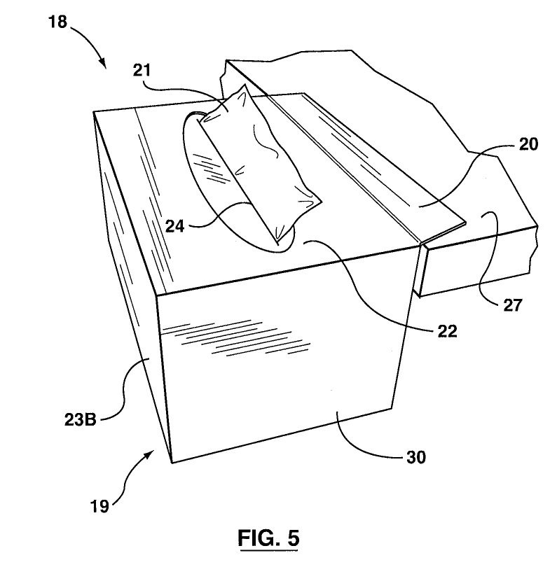

As shown in FIGS. 3 and 4, the affixing tab 20 has a mounting surface 48 with an adhesive 25 thereon for securing the affixing tab 20 to a support surface. Generally, securing the adhesive 25 to the support surface also secures the container 19 to the support surface as will be described in detail below. For example, the adhesive 25 may be an adhesive strip such as double-sided tape.

The adhesive strip 25 on the affixing tab 20 is generally strong enough to hold the container 19 in place. At the same time, the adhesive strip 25 may have a composition such that the affixing tab 20 may be removed from a support surface without marring the surface to which the affixing tab 20 was previous attached or secured. In this sense, the adhesive 25 may be reusable such that it is releasably securable to a support surface.

Furthermore, in some embodiments, after the container 19 and the affixing tab 20 are removed from a support surface, the adhesive strip 25 may retain its effectiveness or adhesiveness such that the affixing tab 20 may be re-attached one or two additional times to another support surface. Similarly, the adhesive strip 25 may be reused to simply hold the affixing tab 20 in the down/closed position as will be described below.

While in some embodiments the adhesive 25 on the affixing tab 20 may be reusable, in other embodiments, the adhesive 25 may be a single use adhesive, or a permanent adhesive.

The affixing tab 20 is moveable between a closed position (e.g. as shown in FIGS. 1 and 2) in which the affixing tab 20 is not in use, and an open position (e.g. as shown in FIGS. 3 and 4) in which the adhesive 25 on the affixing tab 20 can be secured to a support surface.

FIGS. 1 and 2, show the affixing tab 20 in the down/closed position, in which the affixing tab 20 lies flat against the first side panel 23A of the container 18. For example, in the illustrated embodiment, the upper edge of the affixing tab 20 is connected to the top panel 22 of the container 19 (e.g. along the top edge 40) and the inner mounting surface 48 (shown in FIGS. 3 and 4) of the affixing tab 20 rests against the first side panel 23A of the container 19, which extends orthogonally to the top panel 22.

In other embodiments, the affixing tab 20 may extend from the top panel 22 along a different edge, for example, such that the affixing tab 20 rests flat against the second side panel 23B or one of the end panels 30 when the affixing tab 20 is in the closed position. Accordingly, while some embodiments herein refer the affixing tab resting against a “side panel”, the “side panel” as defined herein may include one of the side panels 23A, 23B or one of the end panels 30.

In some embodiments, for example, when the affixing tab 20 is first manufactured, or when the affixing tab 20 is not desired to be used, the affixing tab 20 may be held or “tacked” down in the closed position, for example, using a small amount of adhesive to keep it fastened to the first side panel 23A of the container 19. The adhesive may be one or more glue dots located at point(s) along the mounting surface 48 of the affixing tab 20. The glue dots are generally sufficient to hold the affixing tab 20 in the closed position, yet the glue dots can be easily broken when the affixing tab 20 is lifted up into the open position and put into use.

Referring now to FIGS. 3 and 4, should the user of the dispenser 18 wish to affix the container 19 to a support surface, such as a horizontal or vertical support surface, the affixing tab 20 may be lifted from the down/closed position and moved to the open position. In doing so, the mounting surface 48 is exposed and the adhesive strip 25 on the underside of the affixing tab 20 will become visible. Accordingly, the mounting surface 48 may be secured to a support surface using the adhesive 25. Furthermore, the affixing tab 20 and the adhesive 25 are generally capable of securing to and/or suspending the container 19 from the support surface.

If there are adhesive or glue dots holding or “tacking” the affixing tab 20 down in the closed position, minimal force is needed to break the adhesive or glue dots. For example, the use of ones fingertips might be sufficient to break this bond as the affixing tab 20 is moved from the closed position to the open position, such as a horizontal position as shown in FIG. 5 or a vertical position as shown in FIG. 8.

In the illustrated embodiment, in both of the horizontal and vertical positions, as illustrated in FIG. 5 and FIG. 8 respectively, the upper length of the affixing tab 20 remains attached and hinged to the top panel 22 of the container 19 as the affixing tab 20 and the top panel 22 are a continuous piece of material (cardboard or otherwise). In other words, the affixing tab 20 and the top panel 22 are integrally joined together along the top edge 40. In other embodiments, the affixing tab 20 may be a separate member that is distinct from the top panel 22, as will be described below.

Referring now to FIG. 4, the affixing tab 20 is shown as an extension of the top panel 22 of the container 19. The affixing tab 20 may be scored at the point where it becomes the top panel 22 (e.g. the top edge 40) so that the affixing tab 20 can be initially folded or pivoted down and “tacked” into the down/closed position. Accordingly, the scored top edge 40 may form a living hinge that pivotally couples the affixing tab 20 to the container 19. Furthermore, the affixing tab 20 may be pivoted from the closed position to the open position, and such pivotal motion may correspond to a pivot angle ranging from 0° to 270° depending on the final resting place of the affixing tab 20 when it is in the open position. For example, the affixing tab 20 may be pivoted from the closed position C through a pivot angle of about 90° to a horizontal position H1, or through a pivot angle of about 180° to a vertical position V, or through a pivot angle of about 270° to another horizontal position H2 where the affixing tab is folded over to the point where it is adjacent to the top panel 22.

In some embodiments, the adhesive strip 25 may have a protective covering strip (e.g. made of release paper or another suitable material) that covers the adhesive when not in use, and the protective strip may be removed in order for the adhesive to be exposed. Alternatively, other forms of adhesive could be used that may or may not require a protective covering strip.

In some embodiments, the adhesive strip 25 itself may also act as the adhesive which holds the affixing tab in the down/closed position, for example, such that the adhesive strip 25 replaces the glue dots described above. This could be achieved by making the protective covering strip slightly smaller in length than the adhesive strip 25 such that a portion of the adhesive strip 25 is exposed at each end for tacking the affixing tab 20 to the side panel 23A when the affixing tab 20 is in the down/closed position. Accordingly, the adhesive 25 may be reusable such that the adhesive 25 releasably secures the affixing tab 20 to the side panel 23A in the closed position.

Once the affixing tab 20 is in the open position and the adhesive strip 25 is exposed, the container 19 and affixing tab 20 may be attached or secured to a support surface, such as a horizontal support surface (e.g. a table) or a vertical support surface (e.g. a wall), by pressing the adhesive strip 25 onto the support surface.

Referring to FIGS. 5-11, the dispenser 18 may be secured to a variety of different support surfaces. Furthermore, each of these positions may require the affixing tab 20 to be pivoted through a different pivot angle, ranging from 0° to 270°, when moving the affixing tab 20 from the closed position to the open position.

Referring to FIG. 5, the affixing tab 20 of the dispenser 18 may be secured to a table 27 with the container 19 suspended over the side of the table 27. While the illustrated embodiment refers to a table 27, the affixing tab 20 may be secured to other top facing horizontal support surfaces such that the container 19 overhangs an edge of the horizontal support surface.

When securing the affixing tab 20 to a horizontal support surface such as the table 27, the affixing tab 20 is generally pivoted from the closed position to the open position through a pivot angle of about 90°. Accordingly, the top panel 22 and the affixing tab 20 are generally parallel to each other, as well as parallel to the support surface.

One advantage of the subject dispenser 18 over prior art is that the affixing tab 20 of the subject dispenser 18 may be attached to a horizontal support surface or table 27 of any thickness with the container 19 overhanging the edge of the table 27. Prior attempts to create such an adhesive mechanism, such as the dispenser disclosed in U.S. Pat. No. 2,990,950 (Alexander), required a minimum table-edge-thickness equal to almost the height of the dispensing container. For example, the Alexander dispenser has two tabs extending from a side panel along two opposing vertical edges that adjoin the side panel and the end panels. Accordingly, when attaching the Alexander dispenser to a table such that the dispenser hangs from the side of the table (similar to the how the dispenser 18 overhangs the table 27 as shown in FIG. 5), the table needs to have a vertical side surface with a minimum height such that the adhesive on the tabs of the Alexander dispenser is sufficient to support the dispenser. If the vertical side surface of the table is too short or otherwise has limited surface area, the adhesive on the tabs of the Alexander dispenser would be insufficient to support the dispenser from the table.

Such is not the case with the dispenser 18 described herein because the affixing tab 20 extends from the top panel 22, opposed to the side panel as in the Alexander dispenser. Accordingly, the affixing tab 20 of the dispenser 18 described herein can be attached to the horizontal surface of the table 27, opposed to the vertical side surface of the table 27 as required with Alexander dispenser. Since the affixing tab 20 is attached to the horizontal surface, the table 27 does not need a vertical side surface, let alone a vertical side surface with a minimum height.

Another benefit of the subject dispenser 18 is that attaching the affixing tab 20 to the horizontal surface of the table 27 tends to be more secure than attaching other dispensers, such as the Alexander dispenser, to a vertical surface. For example, when pulling horizontally on the dispenser 18, the shear forces required to break the bond between the adhesive 25 and the horizontal support surface of the table 27 are greater than the tensile forces required to break the bond between the vertical support surface and the adhesive on the Alexander dispenser.

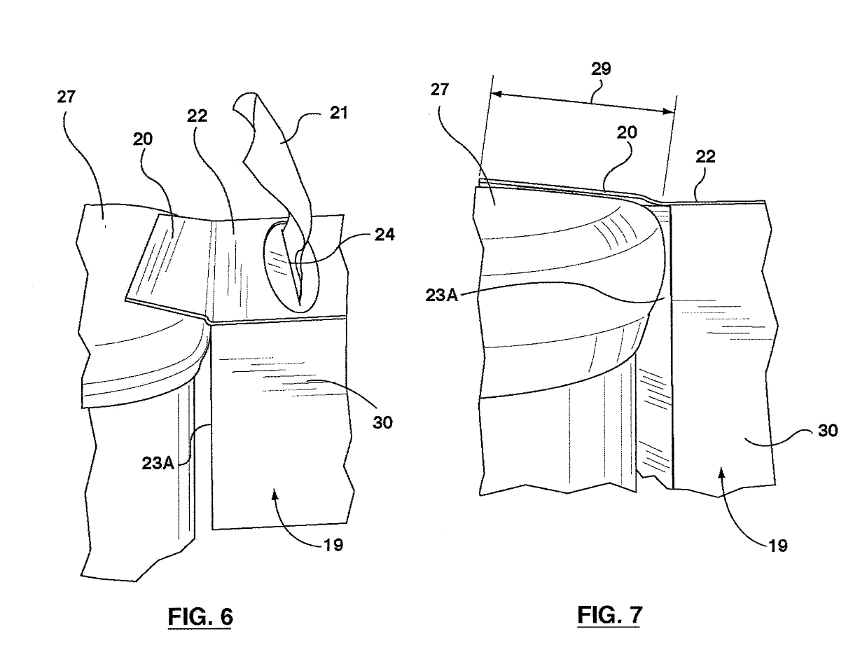

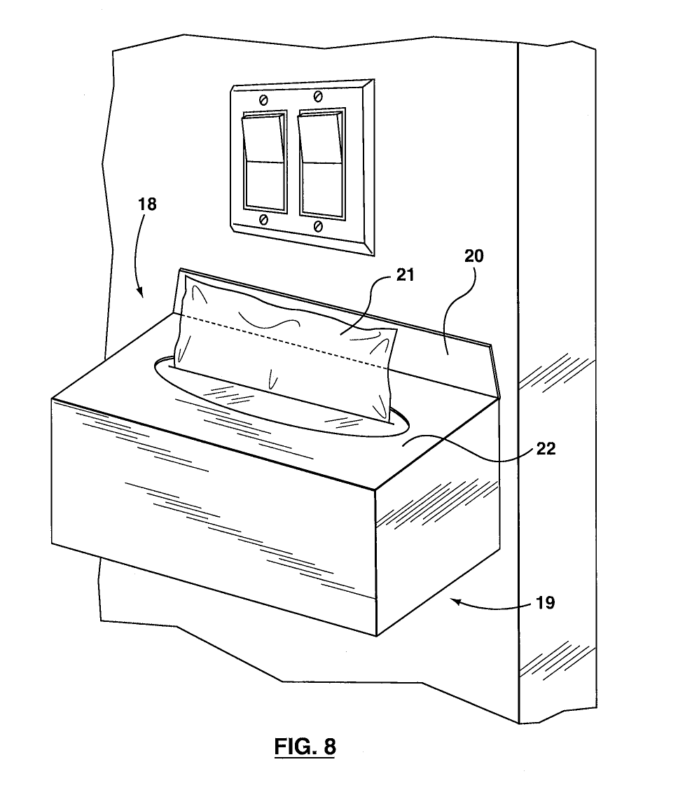

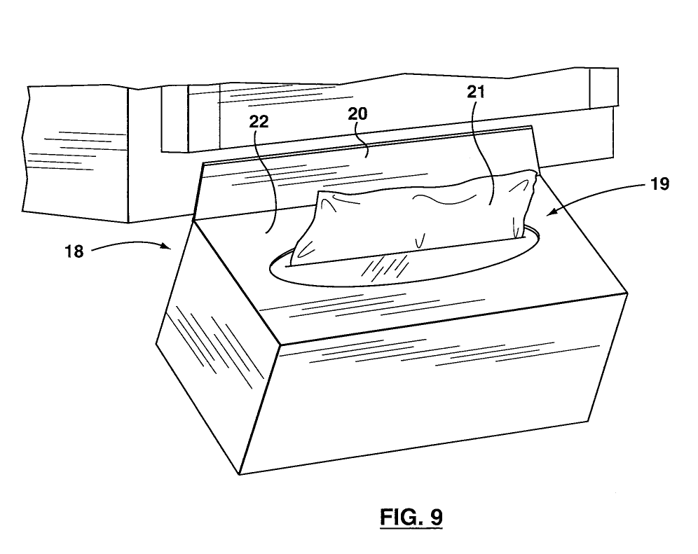

Referring to FIGS. 6 and 7, the dispenser 18 may be hung or suspended from a horizontal support surface (e.g. a table) that has a rounded edge. Although the width 29 of the affixing tab 20 may vary in its design according to the size of the dispenser 18 into which it is incorporated, in one application, it was found that an affixing tab 20 with a width 29 of 3.2 cm allows the container 19 to be suspended from a table top 27 (or other horizontal support surface) having a rounded edge with radius of up to 2 cm. This would not be possible with the Alexander dispenser or other similar prior art dispensers.

Referring to FIG. 8, the dispenser 18 may be hung from a vertical support surface such as a wall. Once the affixing tab 20 is opened and placed in a vertical position and the adhesive strip 25 (not shown) is exposed, the side panel 23A (not shown) of the container 19 and underside mounting surface 48 (not shown) of the affixing tab 20 may be positioned against the vertical support surface (e.g. a wall). By pressing the adhesive strip 25 (not shown) onto the vertical support surface, the container 19 tends to be suspended from, and under, the affixing tab 20.

When securing the affixing tab 20 to a vertical support surface such as a wall, and the first side panel 23A (not shown) of the container 19 rests against the vertical support surface, the affixing tab 20 is generally pivoted from the closed position to the open position through a pivot angle of about 180°.

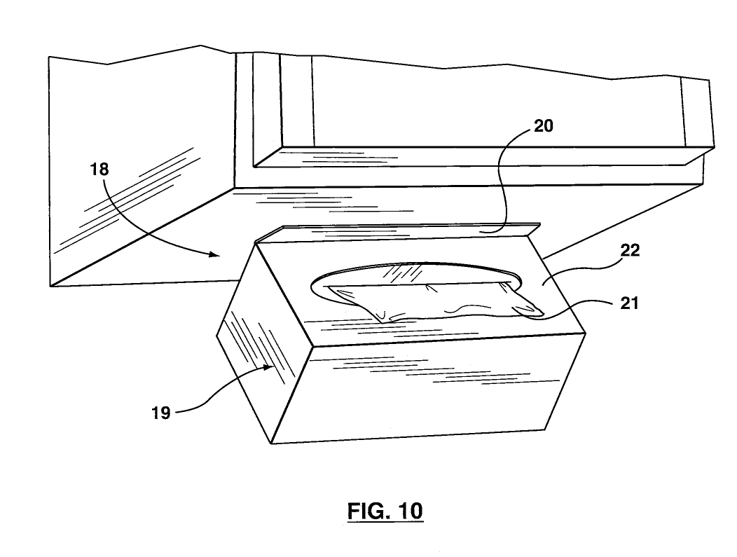

The affixing tab 20 of the dispenser 18 can also be used to suspend the container 19 underneath a horizontal or vertical support surface. For example, as illustrated in FIG. 9, the affixing tab 20 may be secured to a vertical support surface, such that the container 19 is at least partially recessed underneath and behind the vertical support surface. By attaching the affixing tab 20 and the container 19 to the support surface in this fashion, it is possible for the container 19 to remain concealed and unobtrusive, for instance, in an office situation. As illustrated in FIG. 9, this method of attaching the affixing tab 20 and the container 19 can be used in a kitchen to suspend the dispenser from over-the-counter cupboards when counter space is minimal or at a premium.

When securing the affixing tab 20 to a vertical support surface such as a cupboard, and the container 19 is at least partially recessed underneath and behind the vertical support surface, the affixing tab 20 is generally pivoted from the closed position to the open position through a pivot angle between about 90° and about 180°.

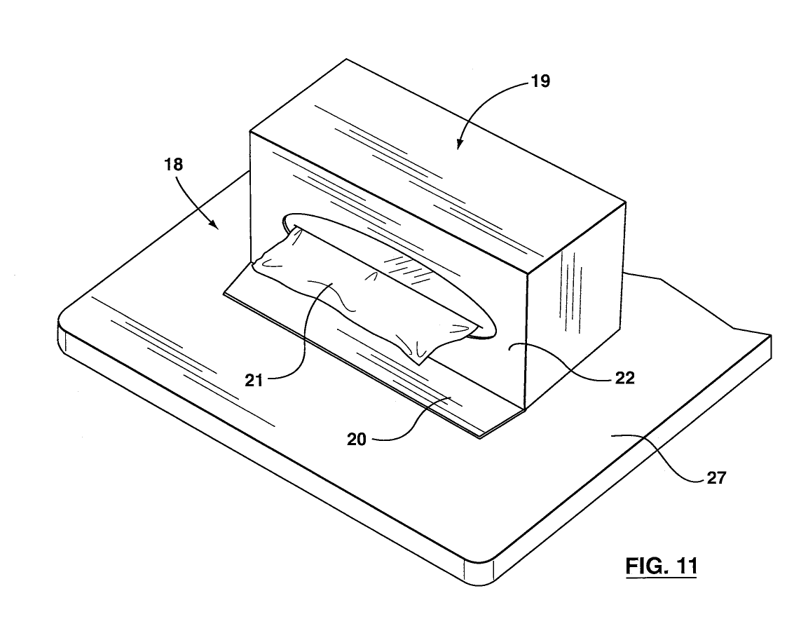

Referring to FIG. 10, the affixing tab 20 of the dispenser 18 can also be used to suspend the container 19 underneath a bottom facing horizontal support surface such as underneath an over-the-counter cupboard.

When securing the affixing tab 20 to a horizontal support surface such that the container 19 is suspended underneath the horizontal support surface, the affixing tab 20 is generally pivoted from the closed position to the open position through a pivot angle between about 180° and about 270°.

Often, when a user pulls a product horizontally from a dispensing container resting on its side, the container tends to move and can, on occasion, make the extraction of the product cumbersome or otherwise difficult. The dispenser 18 described herein tends to solve this problem.

Referring now to FIG. 11, the versatility of the dispenser 18 allows the container 19 to be placed onto a horizontal support surface 27 (e.g. a table) such that the container 19 rests on the first side panel 23A (not shown) and such that the container 19 is secured to the horizontal surface 27 using the affixing tab 20. In this scenario, the affixing tab 20 is used to hold the container 19 down onto the horizontal surface 27 on which the first side panel 23A (not shown) of the container 19 rests. With the adhesive strip 25 (not shown) on the affixing tab 20 securing the container 19 to the horizontal surface 27, a facial tissue 21 (as an example) may be pulled horizontally from the container 19 such that the container 19 remains stationary. In other words, the tissue may be pulled from the container 19 without causing the container 19 to move in the direction of the pulling force.

When securing the affixing tab 20 to a horizontal support surface 27 such that the side panel 23A (not shown) of the container 19 rests on the horizontal support surface 27, the affixing tab 20 is generally pivoted from the closed position to the open position through a pivot angle of about 180°.

In the majority of instances described above, the dispenser 18 enables the container 19 to be placed in new spaces or positions that otherwise did not exist or were not possible using prior art dispensers. The incorporation of the affixing tab 20, and other elements described herein, significantly increases the functionality and practicality of the dispenser 18 by enabling it to be strategically placed and accessed in areas where other dispensers could not otherwise occupy. Furthermore, and in contrast to prior art, the dispenser 18 is versatile in the sense that it can be placed in a variety of positions, opposed to having a different dispenser for each position.

In some embodiments, such as the illustrated embodiment, the container 19 may be an elongate container having an elongate top panel 22 with an elongate top edge 40 and an elongate opening 24 or slit that is parallel to the elongate top edge 40. Furthermore, the affixing tab 20 may be elongate and may be extendable from the elongate top panel 22 along the elongate top edge 40. This elongate configuration tends to increase the ability of the affixing tab 20 to secure the container 19 to a support surface. For example, providing an elongate affixing tab 20 increases the surface area of the mounting surface 48 in comparison to situations where the affixing tab is located on a shorter edge, such as the edge between one of the end panels 30 and the top panel 22. By utilizing the elongate configuration, the larger surface area of the mounting surface 48 enables more adhesive 25 to be applied to the affixing tab 20 and enables more contact area between the adhesive 25 and a support surface.

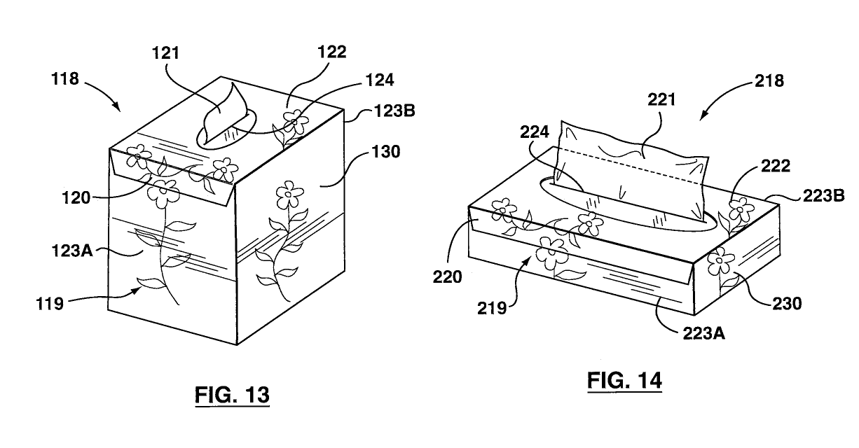

In some other embodiments, the affixing tab 20 may extend from the top panel 22 along one of the shorter edges, for example, as in the embodiment shown in FIG. 13. Accordingly, the affixing tab 20 may be a narrow affixing tab extendable from the top panel 22 along a short top edge.

Referring again to FIG. 4 the top of the first side panel 23A also has a side panel extension 26 that is folded underneath the top panel 22. The side panel extension 26 is attached to the underside of the top panel 22, for example using an adhesive such as glue. This configuration generally allows the container 19 and the affixing tab 20 to be formed from a single piece of material.

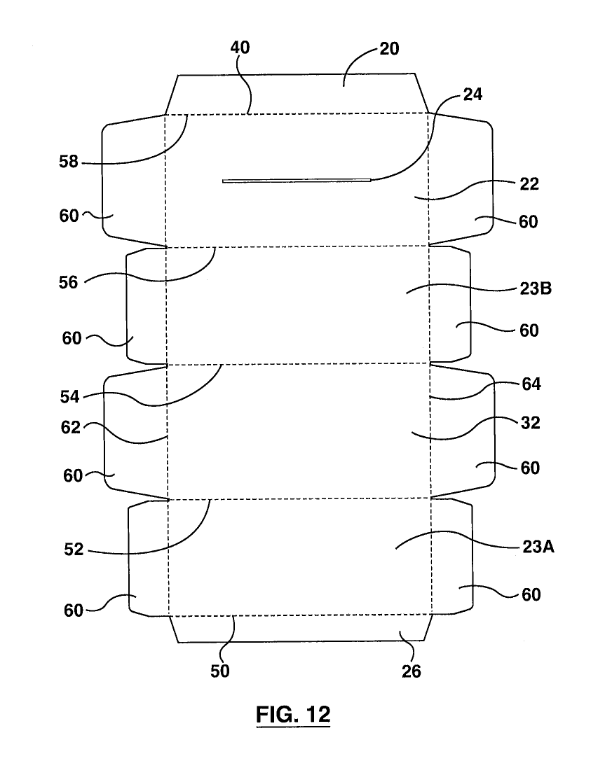

FIG. 12 illustrates a flat cut-out for constructing the dispenser 18. As shown, the side panel extension 26 is formed integrally adjacent the first side panel 23A along edge 50. The first side panel 23A is formed integrally adjacent the bottom panel 32 along edge 52. The bottom panel 32 is formed integrally adjacent the second side panel 23B along edge 54. The second side panel 23B is formed integrally adjacent the top panel 22 along edge 56. The top panel 22 is formed integrally adjacent the affixing tab 20 along edge 58, which corresponds to the top edge 40. The top panel 22 has a slit defining the opening 24 for dispensing tissues or other products from the container 19. The two end panels 30 (not shown) are formed by panel portions 60 at the ends of the top panel 22, the side panels 23A, 23B and the bottom panel 32 defined by edges 62, 64.

Folding the flat cut-out along the edges 50, 52, 54, 56, 58, 62 and 64 allows the panels to be positioned so as to define the dispenser 18, including the container 19 and the affixing tab 20.

It should be understood that the dispenser 18 may have different shapes, sizes and configurations, for example, to fit the specific dimensions and quantity of the intended products that are being placed within the container 19. Accordingly, the flat cut-out may have different shapes, sizes, and configurations depending on the dispenser.

The affixing tab 20 may be incorporated into other dispenser constructions which may or may not be for the purpose of dispensing materials other than tissues so described in the above embodiments, which may then add the additional benefits of the affixing tab without losing the other original benefits associated with particular dispensers.

Referring now to FIGS. 13 and 14, illustrated therein are two dispensers 118 and 218 made in accordance with alternative embodiments of the invention. Dispensers 118 and 218 are generally similar to the dispenser 18 described previously and similar elements are given similar reference numerals incremented by one hundred and two hundred respectively.

The dispenser 118 includes a container 119 and an affixing tab 120 with an adhesive thereon (not shown). The container 119 has a plurality of panels defining a cavity for holding a product such as tissues 121. The panels include a top panel 122, a bottom panel (not shown), two side panels 123A and 123B, and two end panels 130. The top panel 122 has an opening 124 for dispensing the tissues 121 within the container 119.

Similarly, the dispenser 218 includes a container 219 and an affixing tab 220 with an adhesive thereon (not shown). The container 219 has a plurality of panels defining a cavity for holding a product such as tissues 221. The panels include a top panel 222, a bottom panel (not shown), two side panels 223A and 223B, and two end panels 230. The top panel 222 has an opening 224 for dispensing the tissues 221 within the container 219.

One difference is the size and shape of the containers 19, 119, and 219.

The container 119 is taller and more slender than the container 19. Furthermore, the container 119 is shaped more like a cube in comparison to the rectangular construction of container 19. Accordingly, the container 119 may accommodate different products than the container 19. For example, the container 119 may be used for dispensing tissues that are folded in square shapes, as opposed to tissues that are folded in rectangular shapes.

The container 219 is shorter than the container 19, which reduces the overall height of the dispenser 218 in comparison to the dispenser 18. Accordingly, the dispenser 218 may be placed and used in locations that have insufficient space for a taller dispenser.

In some embodiments, the dispenser may have a container with a different size and shape in comparison to the embodiments described above. For example, the containers may be larger, or smaller, or the containers may have different shapes such as rectangular, square, triangular, or otherwise.

Another difference is that the exterior surfaces of the containers 119 and 219, and the exterior surfaces of the affixing tabs 120 and 220 have similar images, designs or patterns, such as a flower pattern as shown in FIGS. 13 and 14.

Referring to FIG. 13, in the closed position, the pattern of the cardboard container 119 tends to make the affixing tab 120 virtually indistinguishable from the container 119 as the printed pattern on the affixing tab 120 tends to be a continuation of, or close approximation to, the printed pattern on the container 119. In other words, the pattern on the affixing tab 120 is a continuation of the pattern on the top panel 122 and tends to blend into the pattern of the side panel 123A of the container 119. Accordingly, the affixing tab 120 visually blends into the printed pattern of the container 119 when the affixing tab 120 is in either the closed or the open position.

Similarly, referring to the dispenser 218 shown in FIG. 14, the affixing tab 220 visually blends into the printed pattern of the container 219 when the affixing tab 220 is in either the closed or the open position.

In some embodiments, the affixing tab may have a different pattern than the container or its adjacent panels. Furthermore, the affixing tab and the panels of the container do not necessarily have to have a particular printed pattern. It is only noted here that in some embodiments the affixing tab can accommodate a printed pattern that matches (i.e., blends into) its adjacent panels.

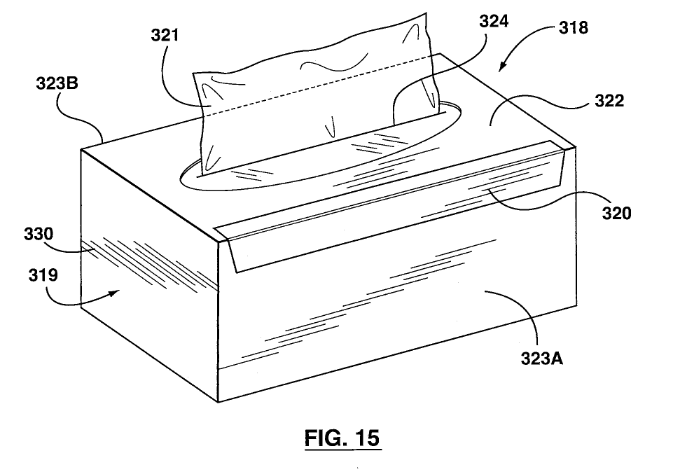

Referring to FIG. 15, illustrated therein is a dispenser 318 made in accordance with another embodiment of the invention. The dispenser 318 is similar in many respects to the dispenser 18 described previously and similar elements are given similar reference numerals incremented by three hundred.

The dispenser 318 includes a container 319 and an affixing tab 320 with an adhesive thereon (not shown). The container 319 has a plurality of panels defining a cavity for holding a product such as tissues 321. The panels include a top panel 322, a bottom panel (not shown), two side panels 323A and 323B, and two end panels 330. The top panel 322 has an opening 324 for dispensing the tissues 321 within the container 319.

One difference is that the affixing tab 320 is created as a separate member (e.g. a separate piece of material apart from the container 319) and is attached to the top panel 322. The use of the affixing tab 320 is generally the same as the affixing tab 20 described above. One difference is that the affixing tab 320 will not be a continuation of the top panel 322. The affixing tab 320 is generally affixed to the top panel 322 using an adhesive such as glue. Attaching the affixing tab 320 to the top panel 322 in this way may achieve one or more of the benefits described above and in other embodiments. Furthermore, the affixing tab 320 may have a pattern that blends into a pattern on the container 319 as described with respect to FIGS. 13 and 14.

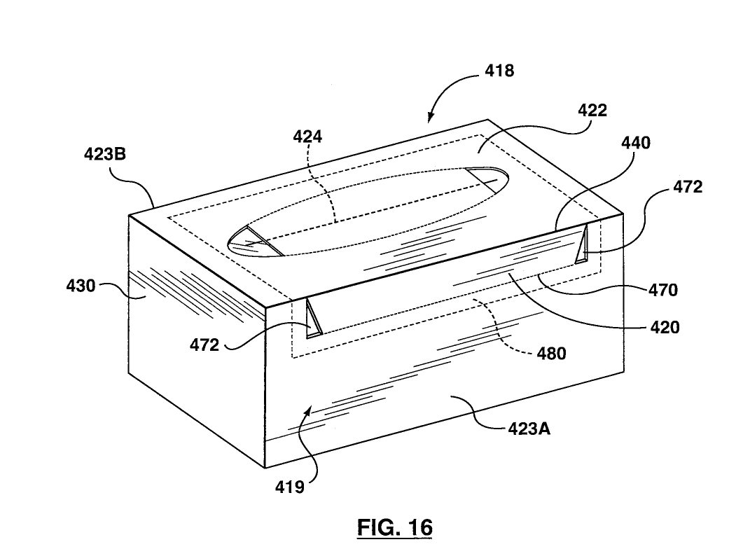

Referring now to FIG. 16, illustrated therein is a dispenser 418 made in accordance with yet another embodiment of the invention. The dispenser 418 is similar in many respects to the dispenser 18 described previously and similar elements are given similar reference numerals incremented by four hundred.

The dispenser 418 includes a container 419 and an affixing tab 420 with an adhesive thereon (not shown). The container 419 has a plurality of panels defining a cavity for holding a product such as tissues (not shown). The panels include a top panel 422, a bottom panel (not shown), two side panels 423A and 423B, and two end panels 430. The top panel 422 has an opening 424 for dispensing the tissues within the container 419.

One difference is that the affixing tab 420 is embedded within the first side panel 423A such that, when the affixing tab 420 is in the closed position, the affixing tab 420 and the side panel 423A are coplanar. This alternative construction is created in an easy and economical fashion by adding perforation holes 470 in the side panel 423A. The perforations 470 are arranged to provide a perforated border between the side panel 423A and the affixing tab 420 such that the affixing tab 420 adjoins the side panel 423A. In the illustrated embodiment, the perforations 470 are located on a lower edge of the affixing tab 420, but in other embodiments the perforations may also be located on the side edges of the affixing tab 420.

When moving the affixing tab 420 from the closed position to the open position, the affixing tab 420 is first ‘punched out’ along the perforated border adjacent to the affixing tab 420 (e.g. along the lower edge of the affixing tab 420). In other words, separating the affixing tab 420 from the side panel 423A along the perforated border, for example, by breaking or tearing the perforated border defined by the perforations 470, allows the affixing tab 420 to move between the closed position and the open position. Furthermore, after being punched out, the affixing tab 420 remains hinged along the top edge 440 where it is attached to the top panel 422 of the container 419. This allows the pivotal movement as described previously with respect to dispenser 18.

As shown in the illustrated embodiment, the top edge 440 extends beyond the affixing tab 420 such that the ends of the top edge 440 connect the side panel 423A to the top panel 422. In other embodiments, the affixing tab 420 may be connected to the top panel 422 along the entire top edge 440 such that the side panel 423A is indirectly connected to the top panel 422 through the affixing tab 420 when the affixing tab 420 is in the closed position.

As described above, the perforations 470 may outline the lower and side perimeter of the affixing tab 420 (leaving it hinged to the top panel 422). Furthermore, the side panel 423A may have openings such as die cut holes 472 on either or both side(s) of the affixing tab 420 for the convenience of getting one's finger in behind the affixing tab 420 to lift out the tab while breaking the perforated border defined by the perforation holes 470.

In the illustrated embodiment shown in FIG. 16, the die cut holes 472 are located at the sides of the affixing tab 420. In other embodiments, the die cut holes 472 may be located adjacent to the lower edge of the affixing tab 420. In such embodiments, the perforated border may adjoin the affixing tab 420 and the side panel 423A along the side edges of the affixing tab and not the lower edge as shown in the illustrated embodiment.

In some embodiments, the side panel 423A may not include die cut holes 472 and the perforated border may extend along the lower edge and both side edges of the affixing tab 420.

One advantage of the dispenser 418 is that the affixing tab 420 is originally kept in the down/closed position (as is the position when it is first manufactured and shipped) without the need for additional glue or other adhesives. This is achieved because the affixing tab 420 is embedded within the side panel 423A until it is put into use. Furthermore, this construction adds no additional width or weight to the dispenser 420 in comparison to the dispensers 18, 118, 218 and 318 described previously.

Yet another advantage of the dispenser 418 is that the affixing tab 420 may be incorporated into existing dispenser designs without modification to the construction process. For instance, the construction of the dispenser 18 as illustrated in FIGS. 1-12 shows a side panel extension 26, which is included on the flat cut-out of the unconstructed dispenser (e.g. as shown in FIG. 12), which is later joined together to become a “box” at the edge where the affixing tab 20 protrudes. While the dispenser 18 may require the side panel extension 26 to be located at a corner corresponding to the top edge 40 between the side panel 23A and the top panel 22, this is not necessary with the dispenser 418 and the side panel extension may be located at a corner other than where the punched out affixing tab 420 is hinged to the top panel 422. In other words, meeting at the same edge is not necessary with the dispenser 418. Accordingly, the dispenser 418 and container 419 may be of any shape or size (e.g. a pentagon-shaped box) and joined along any edge and still be able to utilize this alternate construction of a dispenser having an affixing tab.

The method of using the dispenser 418 in this construction is generally similar to the other constructions, such as dispenser 18. For example, the user lifts the affixing tab 420 by breaking or tearing the side panel 423A box material along the perforations 470 (and perhaps the die cut holes 472 on one or both end(s)). The user lifts the affixing tab 420 up into the open position, such as a horizontal or vertical position, and exposes the adhesive on the mounting surface of the affixing tab 420. The user then secures or attaches the affixing tab 420 to a support surface, which secures or suspends the container 419 from the support surface.

Some contents of dispensers need to be kept relatively sealed even during the period when the dispenser is “open” for dispensing its contents. Accordingly, in some embodiments, the dispenser 418 may include a plastic liner 480 attached to the inner surface of the container 419, allowing a slit through which tissues are available and extracted from the container 419. Although the dispenser 420 has a construction where moving the affixing tab 420 opens the side panel 423A of the container 419, the products within the container 419 may remain sealed by the plastic liner 480, which extends underneath the section of the side panel 423A corresponding to the perforated affixing tab 420. An outline of the plastic liner 480 is shown in FIG. 16.

While FIG. 16 illustrates one example of a plastic liner 480, the plastic liner may have other configurations. For example, in some embodiments, the plastic liner 480 may be two separate liners instead of one continuous liner. Accordingly, the liner may include a first plastic liner spanning the opening 424 in the top panel 422, and a second plastic liner spanning the section of the side panel 423A where the perforated affixing tab 420 exists. Furthermore, in some embodiments, the plastic liner may completely encase the products within the container and need not be attached to the container 419.

It should be understood that the present invention is not meant to be limited to the embodiments described and illustrated therein, and that various modifications can be made to such embodiments without departing from the scope of the invention. In particular, the subject invention is meant to include dispensing containers having affixing devices incorporating a tab, or tabs, that extend from the upper portion of the dispensing container, the tab (or tabs) being used for affixing the container to a surface through the use of an adhesive strip or other affixing method.

Furthermore, the present invention could be used with dispensing containers for dispensing products other than tissues, such as disposable latex gloves.

Furthermore, it should be understood that the dispensers described herein may be used in the same manner as traditional dispensers (for example, without securing or suspending the container from a support surface using the adhesive on the affixing tab).

Other variations and modifications of the invention are possible. All such modifications or variations are believed to be within the sphere and scope of the invention as defined by the claims appended hereto.

1. A dispenser comprising:
a) a container having a plurality of panels defining a cavity for holding a supply of a product, the panels including a top panel having an opening for dispensing the product and a side panel extending orthogonally to the top panel, the top panel being connected to the side panel along a top edge; and
b) an affixing tab extendable from the top panel along the top edge, the affixing tab having a mounting surface with an adhesive thereon, the affixing tab being moveable between:
i) a closed position, in which the affixing tab lies flat against the side panel; and
ii) an open position, in which the mounting surface is exposed and securable to a support surface using the adhesive such that the affixing tab and the adhesive are capable of securing the container to the support surface.

2. The dispenser of claim 1, wherein the affixing tab and the top panel are integrally joined together along the top edge.

3. The dispenser of claim 1, wherein the affixing tab is a separate member affixed to the container.

4. The dispenser of claim 3, wherein the affixing tab is a separate member affixed to the top panel of the container.

5. The dispenser of claim 1, wherein the affixing tab is scored along the top edge so as to form a living hinge that pivotally couples the affixing tab to the container.

6. The dispenser of claim 5, wherein the affixing tab can be pivoted from the closed position to the open position by pivoting the affixing tab by a pivot angle of up to about 270°.

7. The dispenser of claim 6, wherein pivoting the affixing tab from the closed position to the open position by a pivot angle of about 90° allows the container to be secured to and overhang from a top facing horizontal support surface.

8. The dispenser of claim 6, wherein pivoting the affixing tab from the closed position to the open position by a pivot angle of between about 90° and about 180° allows the container to be secured to a vertical support surface.

9. The dispenser of claim 6, wherein pivoting the affixing tab from the closed position to the open position by a pivot angle of between about 180° and about 270° allows the container to be secured to a bottom facing horizontal support surface.

10. The dispenser of claim 1, wherein the adhesive on the mounting surface of the affixing tab is an adhesive strip.

11. The dispenser of claim 1, wherein the adhesive on the mounting surface of the affixing tab is reusable such that the affixing tab can be releasably secured to the support surface.

12. The dispenser of claim 1, wherein a portion of the adhesive on the mounting surface releasably secures the affixing tab to the side panel when the affixing tab is in the closed position.

13. The dispenser of claim 1, wherein the container is an elongate container having an elongate top panel with an elongate opening parallel to an elongate top edge, and wherein the affixing tab is an elongate affixing tab extendable from the top panel along the elongate top edge.

14. The dispenser of claim 1, wherein the container is an elongate container having an elongate top panel with an elongate opening orthogonal to a short top edge, and wherein the affixing tab is a narrow affixing tab extendable from the top panel along the short top edge.

15. The dispenser of claim 1, wherein the container is a tissue box and the product is a tissue, and the cavity of the tissue box is configured to hold a supply of tissues.

16. A dispenser comprising:
a) a container having a plurality of panels defining a cavity for holding a supply of a product, the panels including a top panel having an opening for dispensing the product and a side panel extending orthogonally to the top panel; and
b) an affixing tab extendable from the top panel along a top edge of the top panel, the affixing tab having a mounting surface with an adhesive thereon, the affixing tab being moveable between:
i) a closed position, in the affixing tab and the side panel are coplanar; and
ii) an open position, in which the mounting surface is exposed and securable to a surface using the adhesive such that the affixing tab and the adhesive are capable of securing the container to the surface.

17. The dispenser of claim 16, wherein the side panel has a perforated border between the side panel and the affixing tab for securing the affixing tab in the closed position, wherein separating the affixing tab and the side panel along the perforated border allows the affixing tab to move between the closed position and the open position.

18. The dispenser of claim 17, further comprising a plastic liner attached to the inner surface of the container, the plastic liner extending over a section of the side panel corresponding to the affixing tab.

19. The dispenser of claim 17, wherein the side panel has at least one opening adjacent to the affixing tab for enabling a user to separate the affixing tab from the side panel along the perforated border.

20. The dispenser of claim 16, wherein the affixing tab is scored along the top edge so as to form a living hinge that pivotally couples the affixing tab to the container.
